(19) United States
(12) Patent Application Publication
(10) Pub. No.: US 2003/0142468 A1
(43) Pub. Date: Jul. 31, 2003

(54) Computer and wheeled carrier combination structure

(75) Inventors: Ming-Hwa Chin, Taoyuan Hsien (TW); Kwei Jung Yang, Taoyuan Hsien (TW)

Correspondence Address: BRUCE H. TROXELL, Suite 1404, 5205 Leesburg Pike, Falls Church, VA, 22041, US

(73) Assignee: Enlight Corporation

(21) Appl. No.: 10/054,924

(22) Filed: Jan. 25, 2002

(51) Int. Cl. G06F 1/16; A47B 9/20

(52) U.S. Cl. 361/683; 108/147.19

(57) ABSTRACT

A computer and wheeled carrier combination structure includes a wheeled carrier, the wheeled carrier having a wheel holder frame supported in between a base and a top cover plate thereof and a plurality of wheels respectively pivoted to protruded ends of the wheel holder frame outside the base for moving the wheeled carrier on the floor, a retractable upright vertically fastened to the wheeled carrier, a display module and an operation platform angularly adjustably pivoted to the upright at different elevations, the operation platform having a top keyboard hole holding a keyboard in flush with the top side of the operation platform.

### BACKGROUND OF THE INVENTION

1. Field of the Invention

The present invention relates to computers and, more specifically, to a computer and wheeled carrier combination structure.

2. Description of the Related Art

Regular personal computers include desktop computers, and portable computers. A desktop computer is to be used on a desk. When a desktop computer installed in a desk, is occupies much room space and cannot be conveniently moved with the desk to a different location in the room or office,

### SUMMARY OF THE INVENTION

The present invention has been accomplished under the circumstances in view. According to one aspect of the present invention, the computer and wheeled carrier combination structure includes a wheeled carrier, an upright vertically fastened to the wheeled carrier to hold a display module and an operation platform. According to another aspect of the present invention, the upright is comprised of an inner tube fixedly fastened to the wheeled carrier, an outer tube axially slidably sleeved onto the inner tube, and a lock screw mounted in the outer tube and adapted to lock the outer tube in one of a series of vertically spaced positions. According to still another aspect of the present invention, the display module and the operation platform are angularly adjustably pivoted to the upright at different elevations. According to still another aspect of the present invention, the operation platform has a top keyboard hole, which holds a keyboard in flush with the topside of the operation platform.

### BRIEF DESCRIPTION OF THE DRAWINGS

FIG. 1 is an elevational view of a computer and wheeled carrier combination structure constructed according to the present invention.

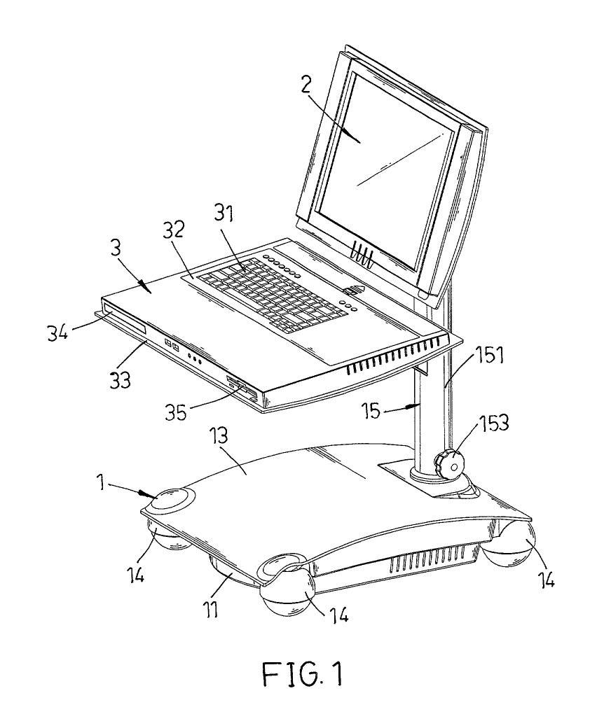

FIG. 2 is an exploded view of the computer and wheeled carrier combination structure shown on FIG. 1.

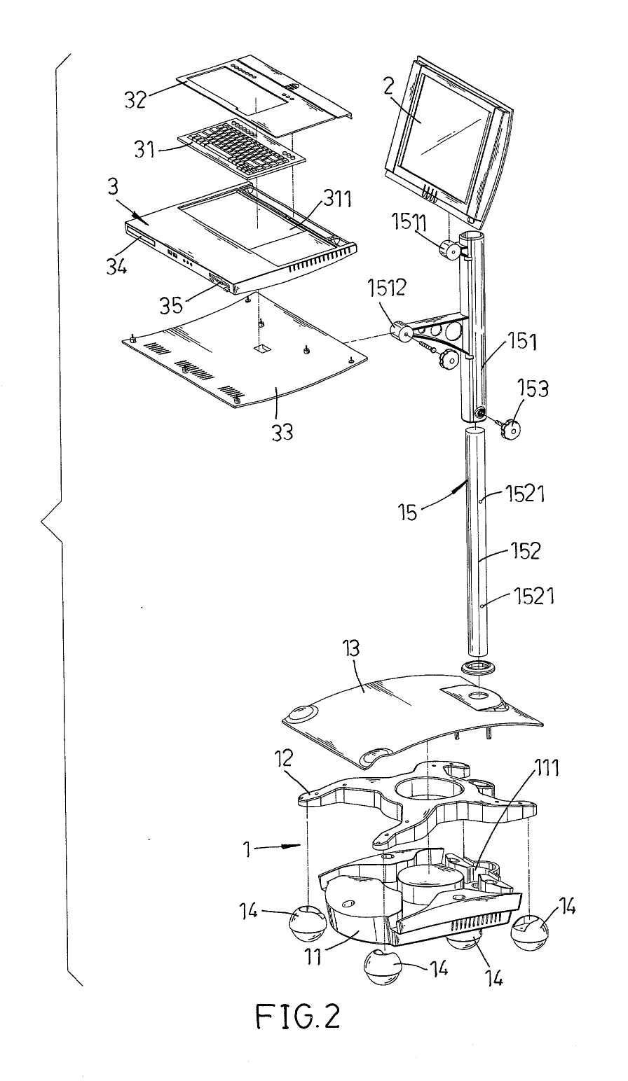

FIG. 3 is an elevational assembly view of the present invention before the connection of the outer tube of the upright to the inner tube.

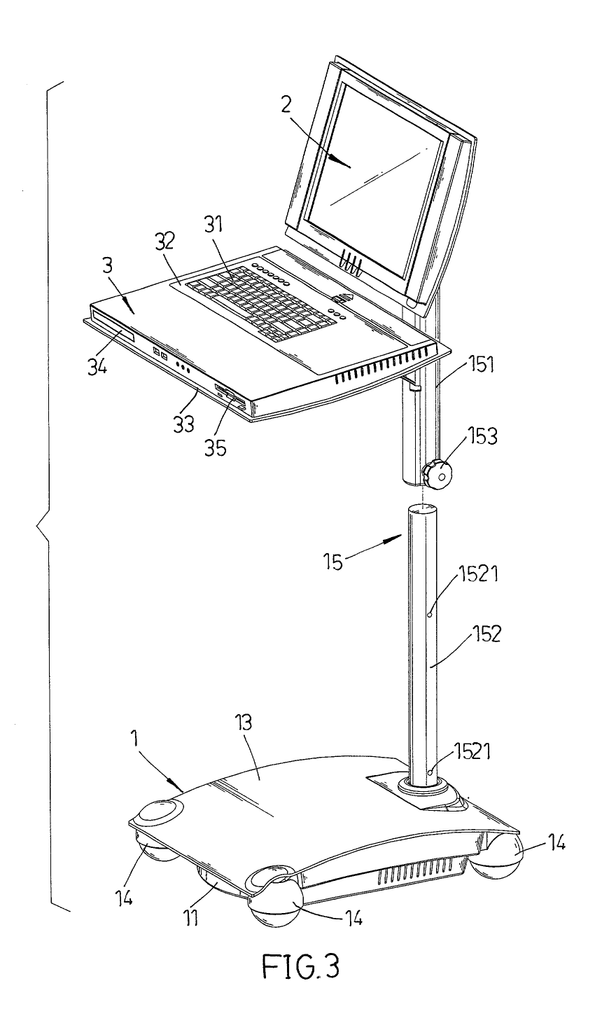

FIG. 4 is a schematic drawing showing the adjustment of the elevation of the upright and the adjustment of the angular position of the operation platform according to the present invention.

FIG. 5 is a schematic drawing showing the adjustment of the elevation of the upright and the adjustment of the angular position of the display module according to the present invention.

### DETAILED DESCRIPTION OF THE PREFERRED EMBODIMENT

Referring to FIGS. from 1 through 3, a computer and wheeled carrier combination structure in accordance with the present invention is shown comprised of a wheeled carrier 1, a display module 2, and an operation platform 3. The wheeled carrier 1 supports the operation platform 3 and the display module 2 for moving from place to place on the floor, comprised of a base 11, a flat wheel holder frame 12, a top cover plate 13, an upright 15, and a number of wheels 14. The base 11 holds the main parts of a host computer (for example, the mainframe, the hard diskdrive, the motherboard, and etc.), and a vertical mounting hole 111 for the mounting of the upright 15. The wheel holder frame 12 is fastened to the topside of the base 11. The top cover plate 13 is covered on the base 11 over the wheel holder frame 12. The wheels 14 are respectively coupled to the protruding four ends of the wheel holder frame 12 outside the base 11 for enabling the wheeled carrier 1 to be smoothly moved on the floor. The upright 15 is comprised of an inner tube 152 fixedly fastened to the vertical mounting hole 111 of the base 11, the inner tube 152 having a longitudinal series of locating holes 1521, an outer tube 151 axially slidably sleeved onto the inner tube 152, the outer tube 151 comprising a locating shaft 1511 transversely disposed near the top end and a bracket 1512 extended from the periphery on the middle below the locating shaft 1511, and a lock screw 531 mounted in the outer tube 151 below the bracket 1512 and selectively fastened to the locating holes 1521 of the inner tube 152 to fix the outer tube 151 to the inner tube 152 in one of a series of vertically spaced positions. The display module 3 is angularly adjustably pivoted to the locating shaft 1511. The operation platform 3 is angularly adjustably pivoted to the bracket 1512, comprising a bottom mounting plate 33 coupled to the bracket 1512, a top keyboard mounting hole 311, a keyboard 31 mounted in the keyboard mounting hole 311, an ornamental cover plate covered on the top side thereof to hold the keyboard 31 in the keyboard mounting hole 311, a CD-ROM player 34, and a diskdrive 35. Further, electric wires are inserted through the upright 15 to connect the display module 2 and the keyboard 31, the CD-ROM player 34, and the diskdrive 35 and other electronic parts of the host computer electrically. The flat top front surface of the operation platform 3 in front of the keyboard 31 is provided for supporting the mouse (not shown). Because the keyboard 31 is disposed in flush with the top side of the operation platform 3, the user can rest the hands on the operation platform 3 to operate the keyboard 31 comfortably.

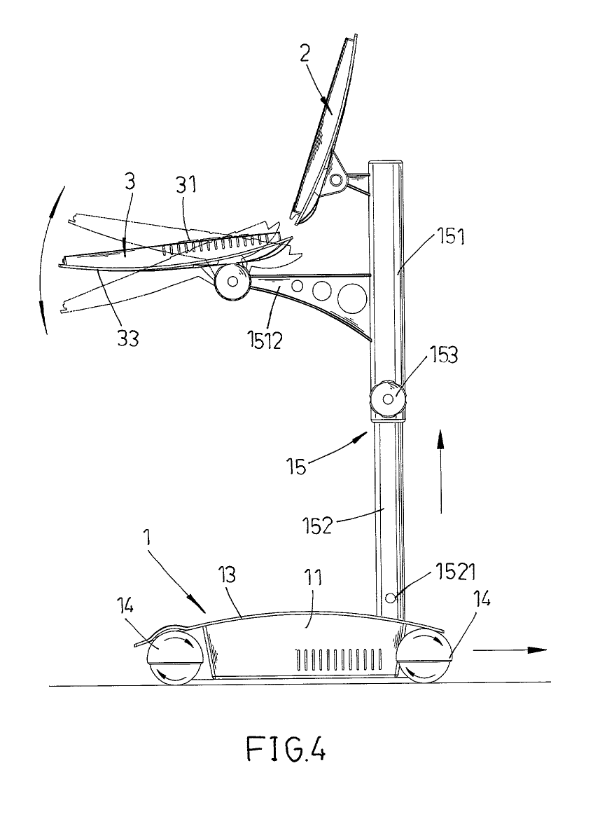

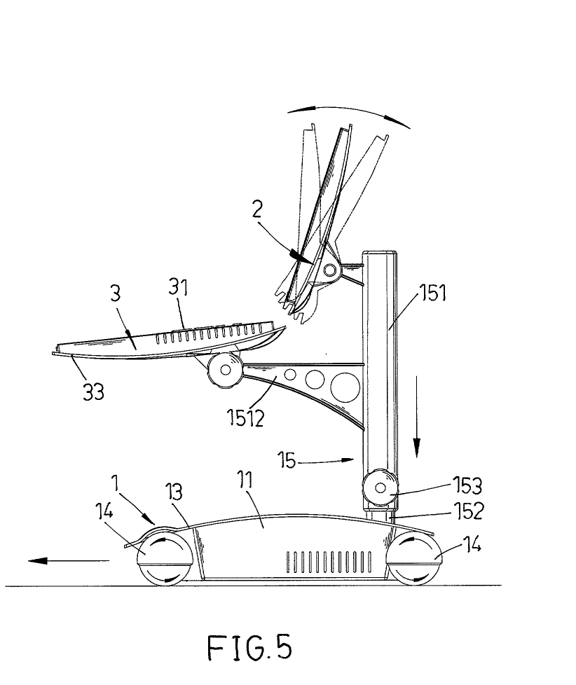

Referring to FIGS. 4 and 5, when in use, the user can move the computer and wheeled carrier combination structure smoothly on the floor to the desired location, and then adjust the elevation of the upright 15 and the angular positions of the display module 2 and the operation platform 3 as desired.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A computer and wheeled carrier combination structure comprising:
a wheeled carrier, said wheeled carrier comprising a base holding the mainframe, hard diskdrive, and main parts of a host computer, said base having a vertical mounting hole, a wheel holder frame fastened to a top sidewall of said base, a plurality of wheels respectively pivoted to protruded ends of said wheel holder frame outside said base for moving said wheeled carrier on the floor, and a top cover plate covered on said base over said wheel holder frame;
an upright, said upright comprising an inner tube fixedly fastened to the vertical mounting hole of said base, said inner tube having a longitudinal series of locating holes, an outer tube axially slidably sleeved onto said inner tube, said outer tube comprising a locating shaft transversely disposed near a top end thereof and a bracket extended from the periphery thereof on the middle below said locating shaft, and a lock screw mounted in said outer tube below said bracket and selectively fastened to the locating holes of said inner tube to fix said outer tube to said inner tube in one of a series of vertically spaced positions;
a display module pivoted to the locating shaft of said outer tube of said upright; and
an operation platform pivoted to said bracket and holding a keyboard, a CD-ROM, and a diskdrive, said operation platform comprising a bottom mounting plate coupled to said bracket, a top keyboard mounting hole, which receives said keyboard, and an ornamental cover plate covered on a top side thereof to hold said keyboard in said keyboard mounting hole in flush with the top side of said operation platform.
